(19) United States
(12) Patent Application Publication
(10) Pub. No.: US 2002/0168779 A1
(43) Pub. Date: Nov. 14, 2002

(54) Device and method for preparing and preserving a personal cell bank, especially for genetic analyses involving DNA analyses

(76) Inventor: Gert Schluter, Endingen (DE)

Correspondence Address: COHEN, POTANI, LIEBERMAN & PAVANE, Suite 1210, 551 Fifth Avenue, New York, NY, 10176, US

(21) Appl. No.: 10/122,941

(22) Filed: Apr. 15, 2002

Related U.S. Application Data
(62) Division of application No. 09/763,778, filed on Feb. 26, 2001.

(30) Foreign Application Priority Data
Aug. 25, 1998 (DE) 198 38 530.7
Aug. 24, 1999 (DE) PCT/DE99/02635

(51) Int. Cl. B01L 3/00

(52) U.S. Cl. 436/174; 422/99; 422/102

(57) ABSTRACT

A method for preparing and preserving a personal cell bank, including the step of adding a preserving agent to a test material.

The invention relates to a device and method for preparing and preserving a personal cell bank, especially for genetic analyses involving DNA analyses, having the features of the preamble of patent claim 1.

In the prior art, so-called saliva specimens are taken from suspects, for example in order to identify the assailant in rape cases. These specimens are in fact smears taken from the buccal mucous membrane, involving cell material being removed from the mucosa by means of cotton swabs and placed in a specimen container. The cell material is isolated in the laboratory, and DNA analysis is carried out on it following suitable preparation procedures. The “genetic fingerprint” thus obtained is used for comparison testing in cases where sperm or traces of blood were found at the scene of crime.

There are a number of DNA analysis methods available to the police records departments and carried out in the appropriate institutions.

Practical experience has shown that conventional forensic identification and diagnostic methods cannot be implemented, or can be implemented only with difficulty, in cases where discovered corpses are missing distinguishing features, for example their dentition. with difficulty, in cases where discovered corpses are missing distinguishing features, for example their dentition.

DNA analyses can also only be carried out if reference material from missing persons is available. For police investigative procedure, this means having to look for material from the missing person's environment, for example hairs (for hair root analysis) or traces of blood. The cost involved in this bears no comparison with the analytical efficiency.

It would be useful if, going beyond the legal provisions, and on a purely personal basis, additional precautionary measures were taken in respect of groups of individuals at particular risk, for example frequent travelers, children, army personnel (in this case by order) members of the German Red Cross, etc.

It is an object of the invention to make available a device and a method permitting such a measure to be taken for each individual.

The cell material is intended to be collected at an authorized site (pharmacy or doctor's practice). However, archiving of a device with its cell content should remain in private hands, or in institutions involved in this procedure and authorized to do so.

In accordance with the object set, the device should hold cell material (for example cells from the oral mucosa), and at the same time the system should permit a preservation of the material which ensures that analyzable cells are available permanently, i.e. even after years have passed.

The feasibility of this has been verified by the inventor, using cell specimens which have been stored for over ten years in an alcohol solution and which in the process have lost neither their morphological properties nor their quantitatively measurable DNA.

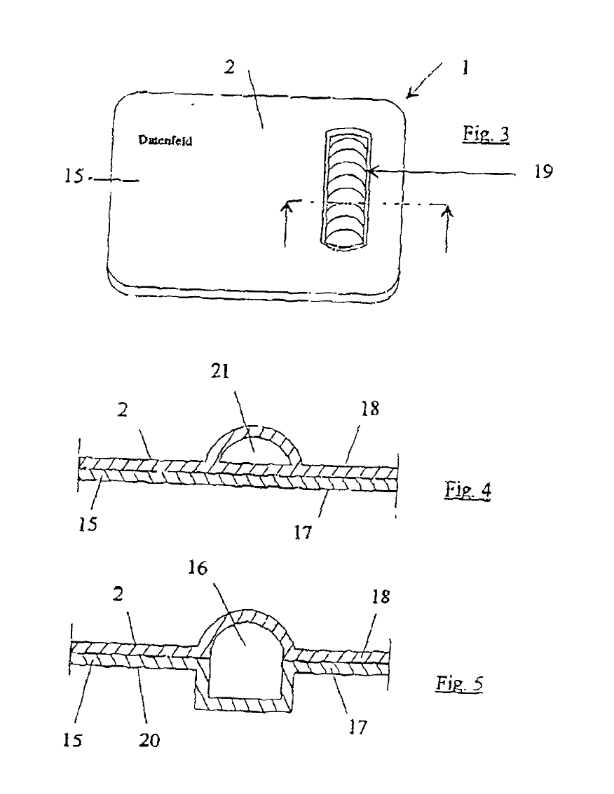

Since the device according to the invention requires that personal data relating to the donor can also be kept safely in conjunction with the specimen, the basic carrier chosen is in the form of a check card 1, represented in FIGS. 1 and 3.

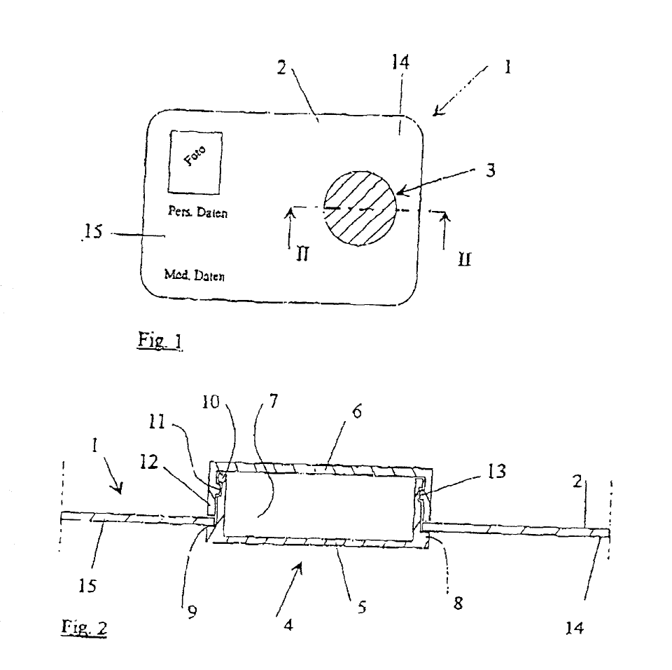

Two thirds of the front face 2 of the card 1 in this case serve as a data carrier. In the remaining third of the card 1, represented in FIG. 1, there is a hole 3 with a diameter of 20 mm which is used to receive a flat capsule 4, represented in FIGS. 2 and 1, which clicks into the opening 3 with edge fit.

The flat capsule container 4 is made of a plastic material which is impermeable to gases and to water and comprises two half-shells 5, 6 which will be referred to as lower part 5 and upper part 6. The lower shell part 5 has a cavity 7 of 4 mm and has, all around its outside, an edge zone 8 which is about 3 mm deep and 2 mm wide.

When the lower part 5 is pushed from below into the card hole 3, it comes up against an abutment at the card hole edge 9. The edge 10 of the lower shell passing through the card 1 (in the present example the latter has a thickness of 0.7 mm) protrudes above the upper face 2 of the card by 2 mm.

The shell edge 10 is provided on the outside with a circumferential groove 11, just above the card upper face 2. The shell-like upper part 6 of the capsule 4 is of such a diameter that it snugly overlaps the lower shell edge 10 via a rounded edge 12. A circumferential bead 13 located on the inside of the edge 12 of the upper part is designed such that, when the lower part 5 is pressed together with the upper part 6, this bead can be pressed by press force into the circumferential groove 11 in the edge 10 of the lower shell.

The specimen capsule 4 is thereby closed firmly and liquid-tight, and its fit in the card hole 3 is secure.

If the specimen material is to be removed from the capsule 4 for analyses, this is only possible if the right-hand card edge 14, represented in FIG. 2, is detached and the capsule 4 is burst open from the side by a lifting force.

This prevents any misuse, for example subsequent filling with material not relating to the person concerned.

In a particular embodiment, the capsule 4 is intended to be used as a separate material carrier (without data card). In this case, round data carriers adapted to the capsule shape 4 are to be made available, and these are to be applied to the lower face and upper face of the capsule.

The above embodiment can be used to secure the identity of newborn babies.

For this purpose, a drop of blood from newborn babies is applied to a carrier made of fabric. After drying, this is fixed with a drop of methanol and, after repeat drying, introduced into the capsule and clipped into place. The device according to the invention should be designed as a dual chamber for this application, so as to be able to accommodate separate blood specimens from mother and child in separate compartments. If there is confusion regarding a child's identity, specimens which have been kept in this way can be used at any time for genetic analyses for identification purposes.

The capsule or dual capsule is designed such that, in the clipped-together state, the circumferential furrow between lower part and upper part (this takes the form of a recess during use of the card) can be used as a suspension means, so that the capsule can be attached to the infant's name tag by way of a string. In this case too, the capsule surface can still be used as a data carrier.

In the illustrative embodiment first described, it is of course also possible to design the capsule 4 as a dual chamber.

Finally, a separate capsule can also be used for decorative purposes or for holding mementoes, and in this case the material configuration can vary. For this purely private use, the user decides on the content of the capsule. This can be liquid or solid. In the example of seawater, sand, hair, cells from a friend, etc., however, a capsule once closed can only be opened with real force and cannot be closed again.

The principal object in making available the device according to the invention lies in its use in the area of forensic medicine, and for this purpose particular method steps are followed in order to obtain material and preserve it for DNA analyses. Practical experience has shown that cells from the oral mucosa in particular are suitable for DNA analysis, especially because the material can be obtained without expense and without causing the donor any inconvenience.

For this reason, the swabbing technique using a cotton swab on a rod or using round disks of fabric gripped by anatomical tweezers was adapted to the device 1 according to the invention.

The mucous membrane lining the cheek is scraped off with the cotton swabs. Alcohol (80% strength) is placed in the lower part 5 of the capsule 4 using a dropper pipet, so that the capsule is half filled.

The swab carrying the material is rinsed in the alcohol, with cell material then being transferred into the solution. Then the capsule 4 is immediately closed. If a disk of fabric (the diameter corresponds to the internal diameter of the capsule 4) is used for obtaining the cells, it is placed in the capsule with the adhering cells and sprinkled to saturation with alcohol. After the capsule 4 is closed, the material lies in a moist chamber, in this technique too, and is permanently preserved. Hair root material can also be introduced into the capsule 4 made up of lower part 5 and upper part 6. Although dry preservation is customary, wetting with alcohol is also recommended here.

The cell material adhering to the fabric disks, in particular cells from the oral mucosa, can also be deposited in a flat cavity arranged in the card carrier. The cavity is adapted to the diameter and thickness of the disk. The cell-carrying fabric disk is introduced in such a way that the cell layer comes to lie facing downward. For the purpose of preservation and/or fixing, the material carrier is sprayed with a polymer mixture, e.g. PVA/cellulose. After the polymers have dried, the material thus enclosed, including cells or hairs, is permanently preserved and can be washed out of the polymer layer with a solvent, for example alcohol, and used for genetic analyses.

The card 15 provided in the device 1 according to the invention as data and capsule carrier is intended also to be constructed with an integrated cell chamber 16 by injection-molding. In the production process, a lower card 17 and an upper card 18 are produced and are joined together by ultrasonic welding.

A groove 19 measuring 30 mm in length and with a width of 3 mm and a depth of 1.5 mm is provided in the third third of each card half. When both card halves 17, 18are joined together, they are congruent and form a chamber. With a card thickness of 1.5 mm, this groove protrudes with its arch above the upper and lower faces 2, 20 of the card by only 1.5 mm.

On the upper face 2 of the card, the chamber has an inlet and outlet opening. When a droplet of liquid is applied to an opening (inlet opening), this droplet is drawn by capillary force into the chamber 16. When the chamber openings are welded or sealed shut on both sides, a closed vessel is obtained, in accordance with the object set, into which vessel a cell specimen from a suspension can be enclosed and can be made available for later DNA analyses.

In another embodiment, according to FIG. 4, this chamber 21 can be designed as a half groove, in which case the holding volume is reduced by half.

The injection-molded card 15 can be used again as data carrier on the front face 2 and as advertising carrier on the rear face.

This device can be advantageously used if, for example, the cells from the oral mucosa are to be transferred from cotton swabs into an alcohol medium. The chamber is in this case filled directly from the specimen vessel using a pipet.

All the device variants satisfy the requirement of being secure against tampering, since introduction of foreign material or additional material is excluded. All the data printed on the front of the card are made available voluntarily by the donor, but they can also be provided in coded form.

The donor will also decide whether his photo should be attached to the front 2.

Cards thus equipped can also carry medical data, for example blood group (Rhesus factor), medical measures to be taken in emergencies, for example in diabetes, etc.

In practice, donors will be offered two cards so that one card can be carried around in private (or also at work) while the other can be kept together with identity papers (pass).

For police records purposes, the whole surface of the card can be covered with a layer of cellulose so that a fingerprint of the person can also be applied alongside the personal data and the genetic material. This embodiment of the card does without cavities and holes, since the cell material too is printed directly onto the surface and fixed by polymer spraying. Immediately after the material has been applied, the carrier card in this embodiment is covered with a self-adhesive transparent film over the entire visible surface. The cells are retrieved for genetic analysis by cutting out the carrier field, pulling off the cover film and washing off the cell material, for example with an alcohol solution.

Patent claims

1. A device for storing material, especially for preparing and preserving a personal cell bank, particularly for genetic analyses involving DNA analyses, characterized in that a material receiver (4; 16; 21) is provided which can be closed and which does not allow for foreign material to be added or for additional material to be added afterward.

2. The device as claimed in claim 1, characterized in that the material receiver is designed as a capsule (4).

3. The device as claimed in claims 1 and 2, characterized in that the material receiver is designed as a capillary specimen chamber (16; 21).

4. The device as claimed in one of claims 1 through 3, characterized in that the material receiver (4; 16; 21) is made in one part.

5. The device as claimed in one of claims 1 through 3, characterized in that the material receiver (4; 16; 21) is made in at least two parts.

6. The device as claimed in one of claims 1 through 5, characterized in that the material receiver (4; 16; 21) has at least two receiving sections/receiving chambers which are separate from each other.

7. The device as claimed in one of claims 1 through 6, characterized in that the device (1) is designed in the form of a check card and has at least one material-receiving section, and card (15) and material receiver (4; 16; 21) are designed such that they can be coupled together.

8. The device as claimed in one of claims 1 through 6, characterized in that the device (1) is designed in the form of a check card, and the material receiver (16; 21) is part of the check card (15).

9. The device as claimed in one of claims 1 through 8, characterized in that the check card (15) is made in at least two parts.

10. The device as claimed in claim 9, characterized in that the check card (15) is formed as a sandwich structure, in particular made up of a lower card (17) and upper card (18) welded together by ultrasonic welding.

11. The device as claimed in one of claims 1 through 10, characterized in that the chambers (16; 21) are an integral part of the check card (15).

12. The device as claimed in one of claims 1 through 11, characterized in that the chamber (21) is an integral part of the upper card (18) of an at least two-part check card (15).

13. The device as claimed in one of claims 1 through 12, characterized in that, after it has been filled and before it is closed, the material receiver (4; 16; 21) can be voided of air and a vacuum can be applied.

14. The device as claimed in one of claims 1 through 13, characterized in that the inlet and outlet opening of the chambers (16; 21) is sealed and can be closed by a quick-drying liquid polymer.

15. A method for preparing and preserving a personal cell bank, particularly for genetic analyses involving DNA analyses, and in particular for use with the device as claimed in one of claims 1 through 14, characterized in that a preserving agent is added to the material that is to be archived.

16. The method as claimed in claim 15, characterized in that an 80% strength alcohol is added to the material.

17. The method as claimed in claim 15 or 16, characterized in that liquid test material is introduced into the capsule (4) and/or into the capillary specimen chambers (16; 21) and is enclosed therein.

18. The method as claimed in one of claims 15 through 17, characterized in that a specimen is taken of the material that is to be stored, e.g. the oral mucosa, 80% strength alcohol is introduced into the capsule (4) using a dropper pipet, the swab carrying the material is rinsed in the alcohol, and in a further method step the capsule is closed.

19. The method as claimed in one of claims 15 through 18, characterized in that a disk of fabric carrying the cell material that is to be stored is placed in the capsule (4) and is sprinkled to saturation with alcohol, and in that, after the disk of fabric has been introduced and sprinkled to saturation, for example with alcohol, the capsule is closed.

20. The method as claimed in claims 15 though 17, characterized in that the chamber is filled using a pipet
